(19) United States
(12) Patent Application Publication
(10) Pub. No.: US 2025/0361754 A1
(43) Pub. Date: Nov. 27, 2025

(54) ONE-PIN HINGE FOR FURNITURE DOORS FITTED WITH RETURN CLOSING MEANS

(71) Applicant: DANCO S.P.A., Veduggio con Colzano (MB) (IT)

(72) Inventor: Roberto CORBETTA, Veduggio con Colzano (MB) (IT)

(21) Appl. No.: 19/191,024

(22) Filed: Apr. 28, 2025

(30) Foreign Application Priority Data
May 21, 2024 (IT) 102024000011455

(51) Int. Cl. E05D 7/04; E05F 3/20

(52) U.S. Cl. CPC E05D 7/04; E05F 3/20; E05D 2007/0484; E05Y 2900/20

(57) ABSTRACT

Hinge for the movement in opening and closing of a door with respect to a shoulder of a furniture item, said hinge including return closing mechanisms, a first fixed part attached to the shoulder, and a second movable part attached to the door, the fixed part and the movable part being articulated one to the other so as to be able to rotate around a pin, which constitutes the axis of rotation of the hinge, wherein the return closing mechanisms include at least one spring arranged around the pin exerting a force in the direction of the axis of the pin in the final phase of closing, tending to rotate coupling surfaces of the fixed part and movable part of the hinge.

### CROSS-REFERENCE TO RELATED APPLICATIONS

Not applicable.

### FIELD OF THE INVENTION

The present invention relates to a one-pin hinge for the opening and closing of furniture doors provided with return means designed to exert a thrust during the phase of closing.

### BACKGROUND OF THE INVENTION

A hinge for furniture normally comprises a fixed part that is attached to a shoulder of the furniture item and a movable part that is connected to the door. The two fixed and movable parts are articulated with each other so as to allow movement of the door with respect to the body of the furniture item.

A “one-pin” or “single-pin” hinge, whereto the invention refers, is so called because the fixed part and the movable part are articulated to each other in such a way as to be able to rotate around a single pin, which forms the axis of rotation of the hinge.

Most one-pin hinges lack return means, which in other types of hinges make closure of the door automatic, so that the user has to manually accompany the door until it is fully closed.

Return systems have been proposed in one-pin hinges which, however, do not meet the needs of users.

For example, IT 102016000012259 proposes the use of an assembly of magnets that is mounted on a profile of an aluminum door that co-operates with a corresponding assembly of magnets mounted on the movable arm of the hinge. The magnets are also associated with pistons that oppose the action of the magnets to cushion the closing of the door.

A disadvantage of this system is that the magnets exert their action only in the last degrees of door closure, limiting the return effect.

Another disadvantage is constituted by the fact that an assembly of magnets is provided, separate from the hinge, which has to be attached to the door profile, which also has an aesthetic impact.

IT 102021000024320 proposes a return system comprising springs provided in the movable part of the hinge, in the direction of the longitudinal extension of the same, which act against cam elements integral to the fixed part.

Such an arrangement of the springs increases the dimensions of the hinge and requires that they be concealed in the door profile so that they do not remain visible.

Therefore, a further limitation of this system is that it is solely suitable for aluminum doors.

U.S. Pat. No. 5,152,029A describes a one-pin hydraulic hinge which, when it is in the position of opening, a further thrust in opening causes the self-closure thereof thanks to the action of a torsion spring. The pin of the hinge consists of a hollow shaft 30, in which a piston 33 slides under the action of a spring 39, exerting pressure on the fluid contained in a hydraulic chamber 31 which, during operation, is brought into communication with an annular chamber 60 formed externally to this hollow shaft to accelerate or decelerate the movement of the door.

CN 110159119A relates to a hinge with horizontal axis for doors with upward opening, particularly for freezers, in which it is necessary to keep the door open at different angles of opening, overcoming the force of gravity that would tend to bring it to closure. The hinge provides two helical springs of different sizes, arranged coaxially one inside the other, which exert their action more at small and large angles of opening, respectively, acting against a movable spiral body, which co-operates with a fixed spiral body.

CN 107165516A relates to a hinge particularly for freezers, the fixed part whereof houses a spring acting on a piston having spiral surfaces that couple with corresponding spiral surfaces provided on the movable part of the hinge. When the freezer door is closed, the spring is compressed and the door slowly closes, with the spiral surfaces always in contact. When the door is opened, the spring releases its force and assists in the opening. The permanent contact between the spiral surfaces does not make it possible to limit the spring's angle of action.

### SUMMARY OF THE INVENTION

The object of the invention is to eliminate the disadvantages of one-pin hinges of the prior art.

In particular, an object of the present invention is to provide a one-pin hinge provided with return means that are completely concealed, without affecting the dimensions of the fixed and movable parts of the hinge, which can therefore be small in size and compact in shape.

Another object of the invention is to provide such a one-pin hinge that can be used indifferently with aluminium and wooden doors.

Another object of the invention is to provide such a hinge that can be easily and quickly mounted on the furniture item.

A further object of the invention is to provide such a one-pin hinge provided with return means, which allows for dampened closure of the door.

Yet another object of the invention is to provide such a hinge that is simple and inexpensive to make and, at the same time, highly reliable.

These and other objects are achieved by the one-pin hinge according to the invention, which has the features listed in the appended independent claim 1.

Advantageous embodiments of the invention are disclosed by the dependent claims.

Substantially, the hinge according to the invention for the movement during opening and closing of a door with respect to a shoulder of a furniture item, provided with return closing means, comprises a first fixed part attached to the shoulder, and a second movable part attached to the door, the fixed part and the movable part being articulated one to the other so as to be able to rotate around a pin, which constitutes the axis of rotation of the hinge, wherein said return closing means comprise at least one spring arranged around said pin exerting a force in the direction of the axis of the pin in the final phase of closing, tending to rotate coupling surfaces of said fixed and movable parts of the hinge in opposite directions.

### BRIEF DESCRIPTION OF DRAWINGS

Further features of the invention will be made clearer by the detailed description that follows, referring to an illustrative embodiment purely by way of non-limiting example illustrated in the accompanying drawings.

FIGS. 1 and 1A are axonometric views of a one-pin hinge according to the invention, open at 180°, applied to a door with aluminum profile and to a wooden door, respectively.

FIGS. 2 and 2A are axonometric views, taken from different angles, rotated through about 90° with respect to FIGS. 1 and 1A, showing the hinge in closed position.

FIG. 3 is a partially blown-up view of the illustration of FIG. 1.

FIG. 4 is a plan view from the top of the illustration of FIG. 1.

FIG. 4A is a sectional view taken along line A-A of FIG. 4.

FIG. 4B is a section taken along line B-B of FIG. 4A.

FIG. 5 is a view of the illustration of open hinge shown in FIG. 1.

FIG. 6 is a sectional view taken along line VI-VI of FIG. 5.

FIG. 6A is an enlargement of the detail denoted by A in FIG. 6.

FIG. 6B is an axonometric view of the hinge alone in the 180° open position taken from the rear of FIG. 5, with a part removed to better highlight a return means.

FIG. 6C is an enlargement of a part of FIG. 6B to better highlight the functioning of the return means.

FIGS. 7-7C and 8-8C are views similar to FIGS. 6-6C, with the hinge in the position of start of return during closure and in the closed position, respectively.

FIGS. 9, 10 and 11 are axonometric views that show successive steps of mounting of the hinge at the shoulder of the furniture item, in which the hinge is shown at 90° opening.

FIG. 12 is a front view of the hinge in the 90° open position of FIG. 11.

FIG. 13 is a section taken along line XIII-XIII of FIG. 12.

FIGS. 14 and 14A are sections taken along line XIV-XIV of FIG. 13, in which the locking element is shown in the inactive and active position, respectively.

### DETAILED DESCRIPTION OF THE INVENTION

Referring to the accompanying drawings, the one-pin hinge according to the invention will now be described in greater detail, denoted overall by reference numeral 1, which hinge can be mounted on aluminum doors and on wooden doors irrespectively.

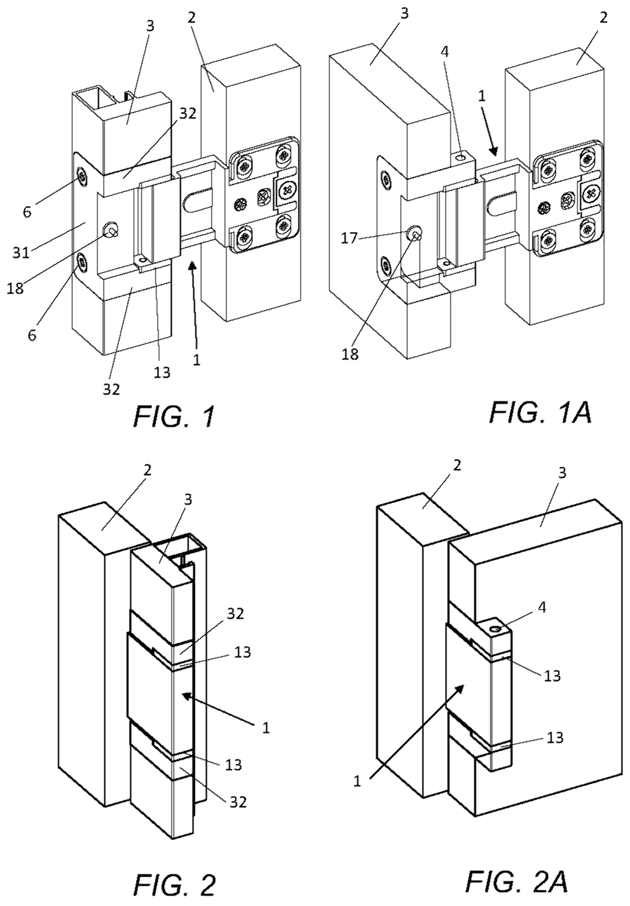

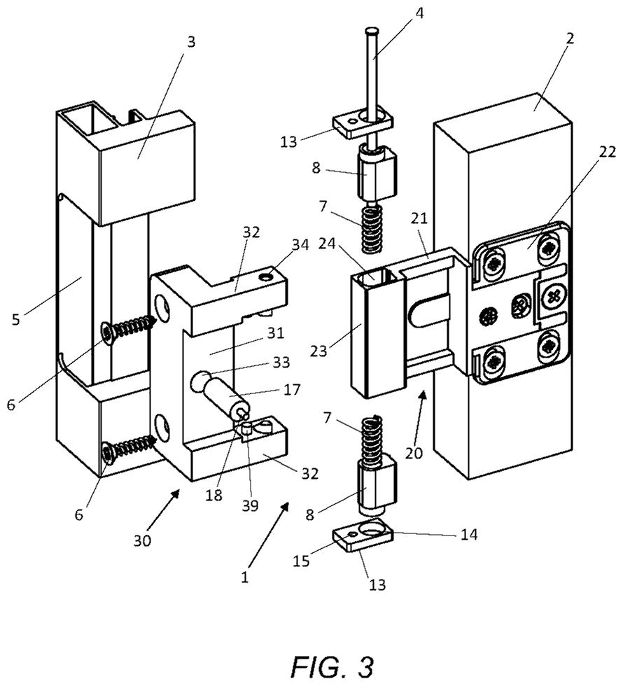

FIGS. 1 and 2 show from different angles, rotated through approximately 90° one with respect to the other, respectively, hinge 1 in the 180° open position and in the closed position, mounted between a vertical wall or shoulder 2 of a furniture item and a door 3 made with aluminum profiles. In these drawings, a vertical profile or upright is actually shown, by which door 3 is identified. Therefore, in the description that follows, reference numeral 3 will be used to denote the door or the aluminum profile that supports it, irrespectively.

FIGS. 1A and 2A, with reference to which the same reference numerals are used, are views similar to FIGS. 1 and 2, with door 3 made of wood.

In all the other drawings, door 3 is shown in aluminum, it being understood that what will be said also applies to the case of a door in wood, the features of the hinge remaining unchanged. Likewise, the shoulder 2 of the furniture item is shown in wood but could obviously be in aluminum.

In the following description, if used, the terms vertical, horizontal, upper, lower, right, left, front, rear, etc., refer to the graphic representations of the drawings and/or to the conditions of mounting of the hinge.

Hinge 1 substantially comprises a fixed part 20 that is attached to the shoulder 2 of the furniture item, and a movable part 30 that is attached to the door 3, the fixed part 20 and the movable part 30 being jointed one to the other in such a way that they can rotate around a pin 4, which constitutes the axis of rotation of the hinge.

The fixed part 20 comprises a support element 21 (so called because it is intended to support the door), which is attached to the shoulder 2 by means of a plate element 22 in the manner to be stated here below.

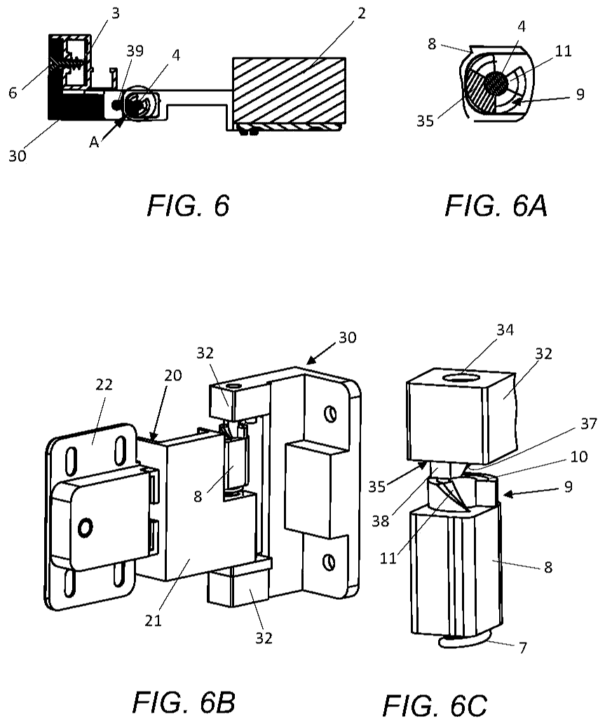

The movable part 30, intended to be housed in a seat 5 formed in the profile of door 3 (or to embrace the thickness of the door in wood) comprises a body 31 with vertical extension, essentially L-shaped (see also FIG. 6B), above and below which protrude a pair of horizontal arms 32, determining a kind of fork, designed to lie flush with the lateral profile of door 3 (see in particular FIG. 2, 2A).

The movable part 30 is attached to the door by means of screws 6 that traverse a wing of the L-shaped body 31.

In the body 31 of the movable part 30 a seat 33 is provided, designed to house a damper 17, of the cylinder-piston type, from which the rod 18 of the piston protrudes (see in particular FIG. 1), serving to slow down the closing stroke of the hinge.

A pair of holes 34, aligned on a vertical axis, are provided in proximity of the ends of the aforementioned arms 32 to accommodate the pin 4 of the hinge.

Pin 4 has a length such that it does not protrude beyond the vertical extension of movable part 30, to which it is riveted.

The support element 21 of the fixed part 20 of the hinge, which has a substantially stepped” shape, has, at the free end, away from the plate element 22 for attachment to the shoulder of the furniture item, an enlarged housing 23 with an internal cavity 24 with a prismatic, or in any case non-circular, profile.

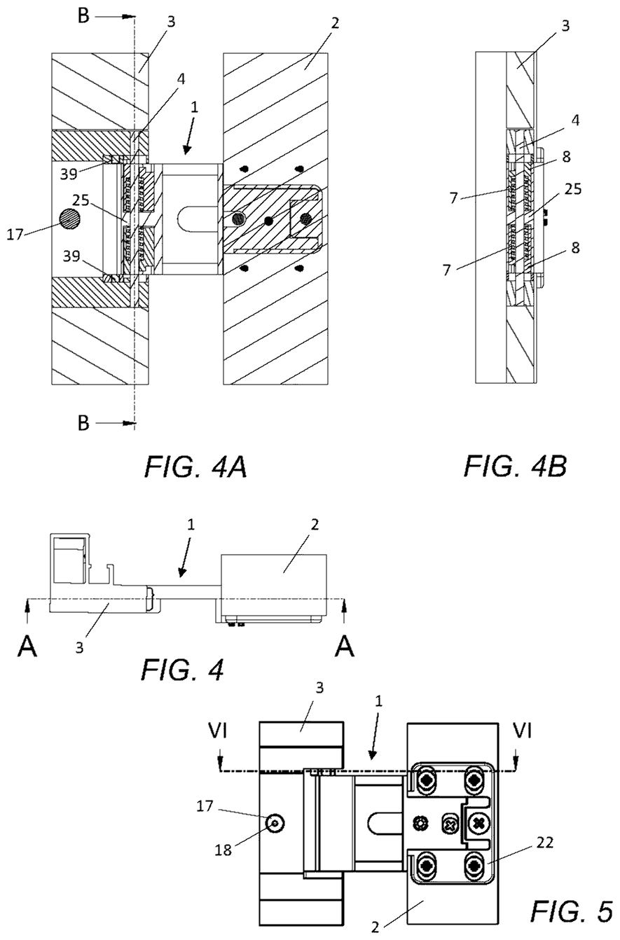

At the mid height of cavity 24 a transverse separation wall 25 is provided, which divides it in two. The wall 25 has a central hole, to allow the passage of pin 4 (see in particular FIG. 4B)

In each of the two halves of cavity 24 are arranged, around pin 4, a helical spring 7 and a block 8, with a central hole and partially hollow, which we shall call a pusher, whose outer profile matches the inner profile of cavity 24, in which it remains locked in rotation, but with the possibility of axial sliding vertically.

Each spring 7 works in compression between the separation wall 25 and the respective pusher 8 in which it is housed, exerting on the same a thrust outwards.

Protruding from the end surface of each pusher 8 is a raised wall 9, which is arranged around the pin 4 for a certain angular extent, for example about 300°, terminating with a flat front edge 10, joined to the base of the pusher with a right-angled end 12 and an inclined plane end 11, covering an arc of approximately 60° (see in particular FIGS. 6C-8C).

Correspondingly, a wall 35 protrudes internally from the arms 32 of the movable part 30 of the hinge, which wall extends around the respective hole 34 for passage of the pin 4 by an angle of approximately 120°. The wall 35 terminates with a flat edge 36 that opposes the flat edge 10 of the raised wall 9 of the pusher and is joined to the base of the arm 32 with a right-angled end 38 and an inclined-plane end 37, which perfectly marries with the inclined plane 11 of the pusher.

In practice, the angular extensions of said shaped walls 9, 35 of pushers 8 and arms 32 are explementary (together they form 360°), with said inclined plane surfaces 11, 37, which have the same angular extension, superimposed one in relation to the other.

The angles indicated for the extensions of the flat edges and of the inclined planes of the walls provided internally to arms 32 and externally to pushers 8 are not limiting and can be varied on the basis of when it is preferred to start the action of return of the hinge, i.e. of the door, as will be mentioned shortly.

To prevent rubbing between the surfaces of the arms 32 and of the support element 21 during the rotation of the hinge, an anti-friction plate 13, preferably made of nylon, acting as a seal, is interposed between them.

The plate 13 is rectangular in shape, with a through hole 14 of dimensions such as to accommodate in its interior the aforementioned wall 35 protruding from the arm 32.

A further hole 15 of smaller dimensions is also provided in plate 13, designed to accommodate a peg 39 protruding from arm 32, in such a way that the plate remains locked in position, without being displaced during rotation of the hinge.

Having described the structure of the hinge in its essential parts, its functioning is now described, in particular the return action during the phase of closure, referring in particular to FIGS. 5 to 8C.

In the enlargements of FIGS. 6C, 7C, 8C, the single pin 4 of the hinge and the anti-friction plate 13 are not shown, in order to highlight better the coupling between the inclined planes of walls 35 and 9.

FIGS. 6-6C show the hinge and its details in the position open at 180°, with the upper pusher 8 on view.

In this position, pusher 8 is in the condition of maximum retraction in seat 24 of housing 23, with spring 7 in the condition of maximum compression.

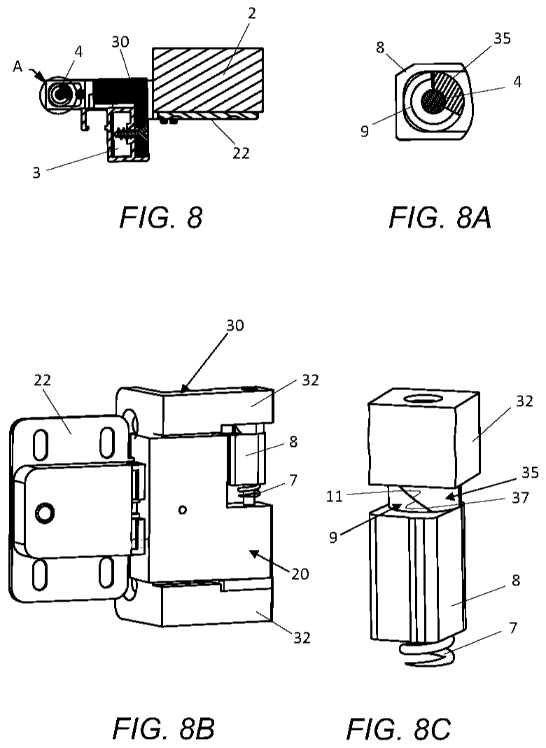

As can be seen in FIG. 8C, the flat edge 36 of the wall 35 protruding from the arm 32 of the movable part 30 of the hinge is arranged on the flat edge 10 of the wall 9 protruding from the pusher 8, without there being contact between the respective inclined planes 37 and 11, as also can be seen from the section in FIG. 6A.

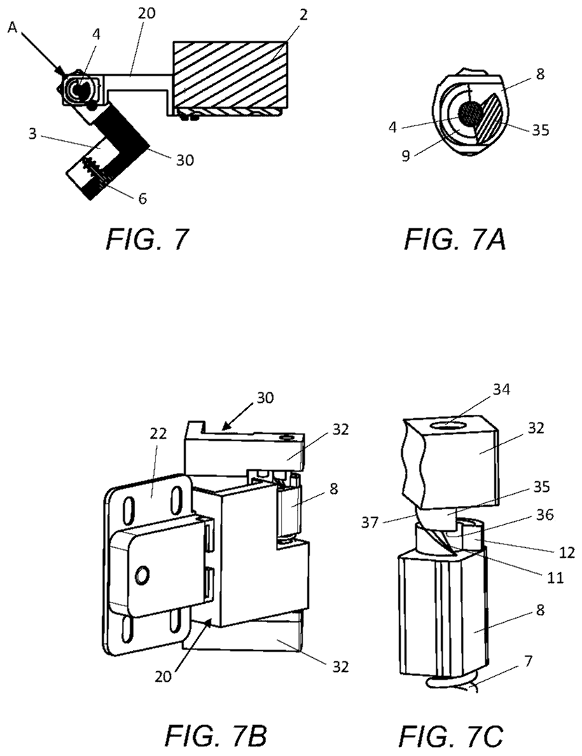

Following a counterclockwise rotation of the door through a predetermined angle, the hinge moves into the position of FIGS. 7-7C, wherein contact between the inclined planes 37 and 11 begins, and then the action of return during closing exerted by the compressed spring 7 which tends to unload.

Starting from this position, spring 7 pushes outwards pusher 8, which, thanks to the engagement of its inclined plane 11 with inclined plane 37, exerts a return force on the hinge up to the fully closed position shown in FIGS. 8-8C, in which the aforementioned inclined planes are fully coupled, with pusher 8 in its condition of maximum extraction. In practice, the action of the spring in the final closing phase of the hinge is exerted on the angular extension of the arch on which said inclined planes 11 and 37 develop.

In the subsequent step of opening of the door, with clockwise rotation, since the inclined planes are already reciprocally engaged, the compression action of spring 7 begins immediately, which reaches the maximum in the position of FIGS. 7-7C, in which pusher 8 is in the condition of maximum retraction in housing 23, to then continue the stroke of opening with the inclined planes disengaged and a sliding between the opposing flat edges 36 and 10.

The closure of the hinge, assisted by the spring return means described above, is slowed down in the last section by the damper 17, whose stem 18 goes to interfere with the support element 21 of the fixed part of the hinge.

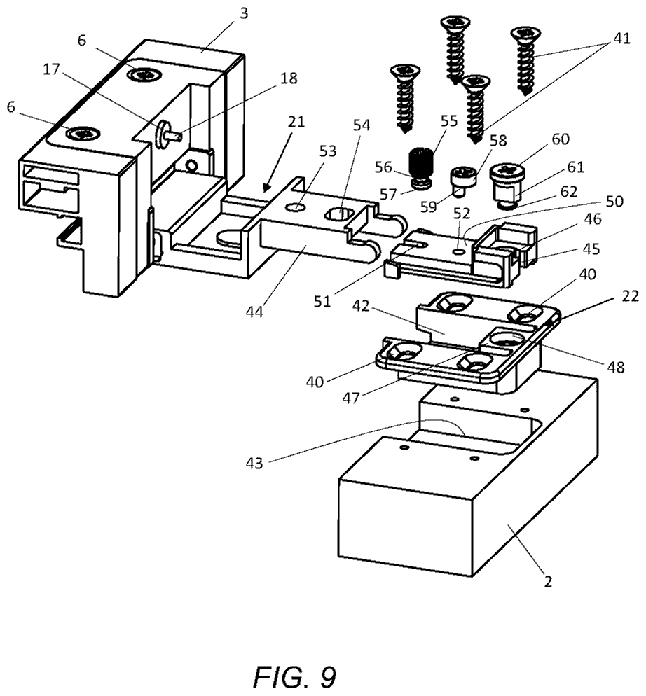

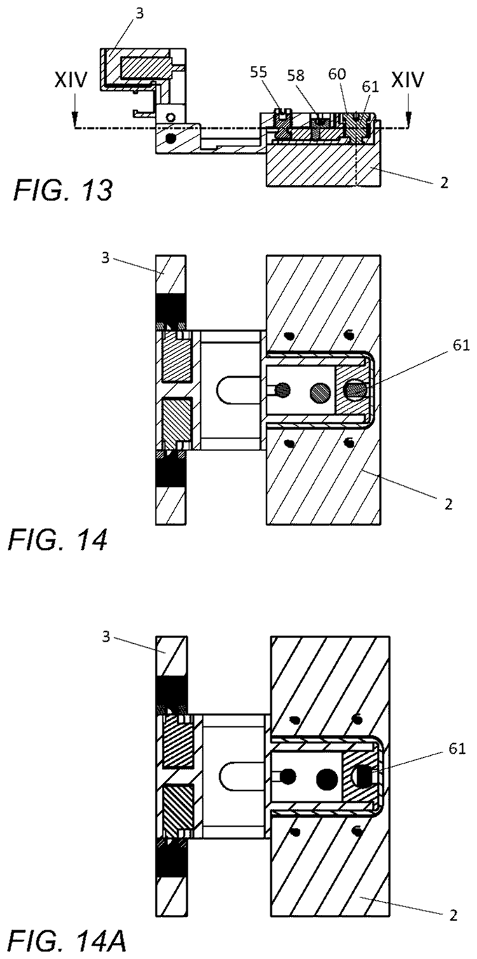

Referring now to FIGS. 9-14A, a system for rapid fixing and mounting of the fixed part 20 of the hinge to the shoulder 2 of the furniture item is described in brief.

The plate element 22 of the fixed part 20 has pairs of slots 40 with vertical extension, for attachment to the shoulder 2 by means of screws 41, with the possibility of vertical regulation.

The plate element 40 has a lowered central part 42, open at least frontally, which is arranged in a seat 43 formed in shoulder 2, and intended to accommodate an arm 44 of the stepped” support element 21

Arm 44 has a substantially C-shaped cross section, such as to be able to accommodate below it, in an adjustable manner, an insert 50 with substantially flat longitudinal extension.

The insert 50 has, in the front part, a slit open frontally, and further back a circular hole 52, suitable for arranging below a threaded hole 53 and an opening 54, respectively, provided on the flat wall of the arm 44.

A screw 55 is screwed into the hole 53, whose shank 56 is inserted in the slit 51 of the insert 50 and ends with a widened end 57 that is arranged below the insert.

In the opening 54 of the arm 44, the head 58 of an eccentric pin 59 is instead arranged, which is inserted in the hole 52 of the insert 50.

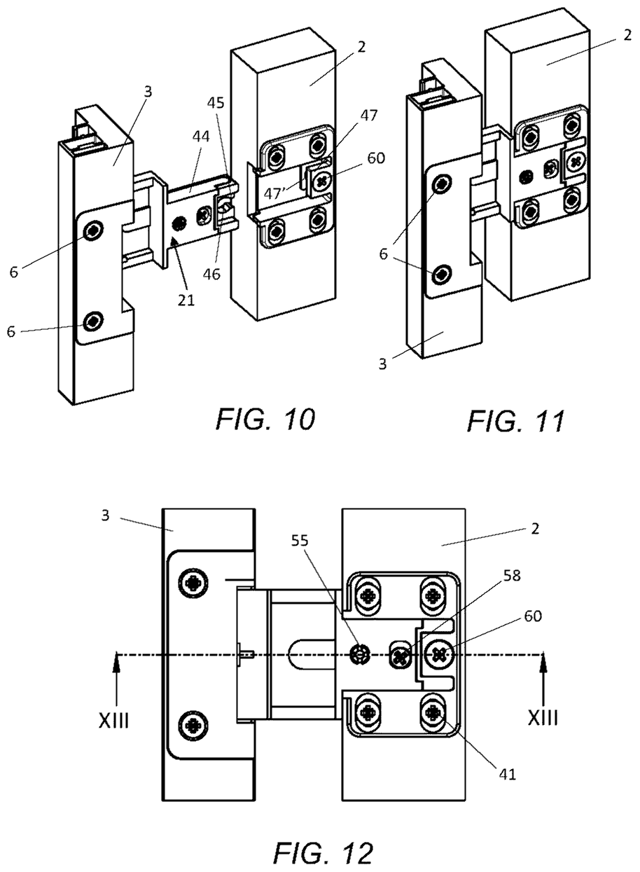

The insert 50 can be preassembled to arm 44, as shown in FIG. 10.

The insert 50 has at the end opposite to the slit 51 a narrowed opening 45, which leads into a hole 46 of greater dimensions.

To the rear of the lowered part 42 of the plate element 22 a fin 47 is provided, provided with a hole 48, at the same level as holes 40, which, when assembled, is arranged above the hole 46 provided in the insert 50.

A pin 60 having a flattened shank 61, such that it has two different dimensions in reciprocally orthogonal directions, is inserted in hole 48 of fin 47, from which a stem with a widened end 62 protrudes and is arranged below an underlying perforated plate 47′ (FIG. 10) to prevent withdrawal thereof.

For the mounting of the hinge at the shoulder of the furniture item, arm 44, complete with insert 50, is inserted in the lowered part 42 of plate element 22 with pin 60 oriented in such a way that it can pass through the narrowed opening 45 of the insert and arrange itself in hole 46, as shown by the section of FIG. 14.

At this point, it is sufficient to rotate pin 60 through 90° to arrange shank 61 in the position shown in the section of FIG. 14A, in which the larger transverse dimension of shank 61 with respect to opening 45 maintains arm 44 locked in position, preventing extraction thereof.

The various screws allow the three degrees of regulation of the hinge, and thus of the door, to be obtained.

As already seen, vertical, i.e. upward and downward, regulation is achieved during the phase of fixing of the plate element 22 with the screws 41 in the slots 40.

Lateral regulation is carried out by screwing/unscrewing screw 55, which causes the arm 44 to be raised/lowered.

Finally, frontal or depth regulation is achieved by acting on the head 58 of the eccentric pin 59, which slides along the inner profile of the opening 54 formed in the arm 44, causing a longitudinal displacement thereof with respect to the insert 50.

From the foregoing, the advantages of the one-pin hinge according to the invention, provided with fully concealed return closing means, which does not affect the dimensions of the hinge, which is therefore to be of reduced dimensions and compact in shape, are clear.

A further advantage of the one-pin hinge according to the invention is that it can be mounted, without substantial modifications, irrespectively on aluminum and wooden doors.

Another advantage is that this hinge can be easily and rapidly mounted on the furniture item.

Naturally the invention is not limited to the particular embodiment previously described and illustrated in the accompanying drawings, but numerous detailed changes can be made thereto within the reach of the person skilled in the art, without thereby departing from the scope of the invention as defined in the appended claims.

1. Hinge for the movement in opening and closing of a door with respect to a shoulder of a furniture item, said hinge comprising return closing means, a first fixed part attached to the shoulder, and a second movable part attached to the door, said movable part having a fork shape, comprising a body with vertical extension and a pair of horizontal arms between which a housing of said fixed part is arranged, or vice versa, the fixed part and the movable part being articulated one to the other so that said movable part may rotate around a pin, which constitutes a vertical axis of rotation of the hinge, traversing said fixed part and movable part, wherein said return closing means comprise at least one spring arranged around said pin exerting a force in the direction of the axis of the pin which, in the final phase of closing, acts on coupling surfaces of said fixed part and movable part of the hinge, comprising inclined planes and, respectively, so as to rotate said movable part with respect to said fixed part.

2. Hinge according to claim 1, wherein said at least one spring is arranged in a seat of said housing provided in said fixed part of the hinge and acts against a pusher also arranged in said seat without possibility of rotation, and bearing on the surface facing outwards from said housing a shaped wall developing around the pin, co-operating with a corresponding shaped wall provided internally to at least one of the arms of said movable part in the shape of a fork, or vice versa, said shaped walls bearing said inclined plane coupling surfaces tending to rotate said movable part with respect to said fixed part of the hinge said inclined plane coupling surfaces extending over an arc which determines the angle of action of said at least one spring.

3. Hinge according to claim 2, wherein said shaped wall of the pusher terminates with a flat front edge, connected at the base of the pusher with said inclined plane surface, and said shaped wall provided internally to said arm ends with a flat edge that is opposed to the flat edge of the shaped wall of the pusher, and is connected at the base of the arm with said inclined plane end, which matches perfectly the inclined plane of the pusher.

4. Hinge according to claim 3, wherein the angular extensions of said shaped walls of the pusher and arm are explementary, with said inclined plane surfaces, which have the same angular extension, overlapping each other.

5. Hinge according to claim 3, wherein said shaped wall of the pusher has an angular extension of approximately 300° and said shaped wall provided internally to said arm has an angular extension of approximately 120°, said inclined plane surfaces having an angular extension of approximately 60°.

6. Hinge according to claim 2, wherein said housing are arranged a pair of springs that work in opposition against respective pushers, with respective shaped walls co-operating with corresponding shaped walls provided internally to both arms of said movable fork-shaped part.

7. Hinge according to claim 1, wherein, around said pin between the surfaces of said fixed part and movable part, is interposed an anti-friction plate.

8. Hinge according to claim 1, wherein between said fixed part and movable part there is interposed a damper suitable for slowing down the last section of the closing stroke of the door.

9. Hinge according to claim 2, wherein said fixed part of the hinge comprises a support element bearing at one end said housing for the return means and at the other end a quick-locking arm by means of an underlying insert in a plate element attached to the shoulder of the furniture item.

10. Hinge according to claim 9, wherein said fixed part provides means of vertical, front and lateral adjustment of the hinge.
